(19) United States
(12) Patent Application Publication
(10) Pub. No.: US 2023/0419569 A1
(43) Pub. Date: Dec. 28, 2023

(54) VECTORIZATION FOR OBJECT DETECTION AND ROBOTICS

(71) Applicant: VY Corporation, Wayne, PA (US)

(72) Inventors: Thomas Martel, Manlius, NY (US); John Freyhof, Cambridge, MA (US)

(73) Assignee: VY Corporation, Wayne, PA (US)

(21) Appl. No.: 18/213,331

(22) Filed: Jun. 23, 2023

Related U.S. Application Data
(60) Provisional application No. 63/354,749, filed on Jun. 23, 2022.

(51) Int. Cl. G06T 11/20; G06T 7/13; G06V 10/44

(52) U.S. Cl. CPC G06T 11/203; G06V 2201/07; G06V 10/457; G06T 7/13

(57) ABSTRACT

A Shape-Based Modeling Segmentation (SBMS) system is provided for differentiating compact objects having finite boundaries from extended objects. The SBMS system includes a Bézier curve system to fit generated Bézier curves on edges parsed from an object in an image. The SBMS system also includes a CPELinear platform to identify the Bézier curves in a predefined proximity, the Bézier curves having at least one of a geometric relationship and a reporting relationship with other Bézier curves in the predefined proximity, detect linear objects having slightly curved or linear boundaries identified from the Bézier curves, and connect the Bézier curves to identify the object in the image.

### CROSS-REFERENCE TO RELATED APPLICATIONS

The present application is related to and claims benefit under 35 U.S.C. § 119(e) from U.S. Provisional Patent Application Ser. No. 63/354,749, filed on Jun. 23, 2022, the entire contents of which are incorporated herein by reference.

### BACKGROUND

In, for example, orbital manufacturing, a robot on a satellite may be used to build a structure such as a space station or solar panels in a zero-gravity environment.

The robot may have to connect objects such as a flange to a bolt, fasteners, and connectors, or insert one object into another object. In making connections, the robot may have to align two objects that have cylindrical symmetry and bring them together along their shared center line and detect the ellipses and straight lines at any angle or scale within a field of view. Before the robot can assemble these objects, the robot may have to identify objects in its field of view. Some objects may have finite boundaries, including curves, and some linear objects may have extended boundaries. A distinction needs to be made between linear or curved objects to determine the finite boundaries of an object.

In another example, one may use computers to identify objects in an image captured from, for example, a drone or any camera. In analyzing the image, one may have to differentiate compact objects such as buildings or other objects having finite boundaries from extended objects, such as roads, rivers, railroad tracks, pipelines, power lines, or shorelines that may extend over long stretches.

### SUMMARY

In some implementations, a method is provided for differentiating compact objects having finite boundaries from extended objects. The method includes fitting generated Bézier curves on edges parsed from an object in an image, by a Shape Based Modeling Segmentation (SBMS) system. The method also includes identifying, by the SBMS system, Bézier curves in a predefined proximity, the Bézier curves having at least one of a geometric relationship, and a reporting relationship with other Bézier curves in the predefined proximity. The method further includes detecting linear objects having slightly curved or linear boundaries identified from Bézier curves, and connecting, by the SBMS system, the Bézier curves to identify the object in the image.

In some implementations, the SBMS system includes a Bézier curve system to fit generated Bézier curves on edges parsed from an object in an image. The SBMS system also includes a CPELinear platform to identify the Bézier curves in a predefined proximity, the Bézier curves having at least one of a geometric relationship and a reporting relationship with other Bézier curves in the predefined proximity, detect linear objects having slightly curved or linear boundaries identified from the Bézier curves, and connect the Bézier curves to identify the object in the image.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate implementations of concepts, and explain various principles and advantages of those implementations.

FIG. 1 is a block diagram of a Shape Based Modeling Segmentation (SBMS) system used in accordance with some implementations.

FIG. 2 shows wraptangles used in accordance with some implementations.

FIG. 3 shows a Class Perimeter Element Convex (CPEConvex) class in accordance with some implementations.

FIG. 4 shows an extended object and a Class Perimeter Element Linear (CPELinear) class in accordance with some implementations.

FIG. 5 shows an up-sampled image of a house processed using a CPELinear platform in accordance with some implementations.

FIGS. 6-8 show a progressive analysis of the house of FIG. 5 using the CPELinear class in accordance with some implementations.

FIG. 9 shows the longitudinal TriBéziers in accordance with some implementations.

FIG. 10 shows further analysis of the up-sampled image of FIG. 5 in accordance with some implementations.

FIG. 11 shows an image including Bézier representing the upper right of the house in accordance with some implementations.

FIG. 12 shows an image including Bézier representing the lower right of the house in accordance with some implementations.

FIG. 13 shows an image including Bézier representing the lower left of the house in accordance with some implementations.

FIG. 14 shows an image including Bézier representing the upper left of the house in accordance with some implementations.

FIG. 15 shows an image including Bézier representing diagonally opposing pairs in accordance with some implementations.

FIG. 16 shows an image including Bézier representing a group of three right-angle primitives in accordance with some implementations.

FIG. 17 shows an example of the coordinate system in accordance with some implementations.

FIGS. 18 and 19 show how CPELinear class Elements may be used to reliably identify objects in accordance with some implementations.

FIG. 20 shows two separate cables that need to be connected at any arbitrary angle in accordance with some implementations.

FIG. 21A-21C shows the cable ends brought to proximity along a mutual radial axis in accordance with some implementations.

FIG. 22 shows a block diagram of a computing device on which SBMS system 100 may be executed in accordance with some implementations.

FIG. 23 shows steps implemented in accordance with some implementations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

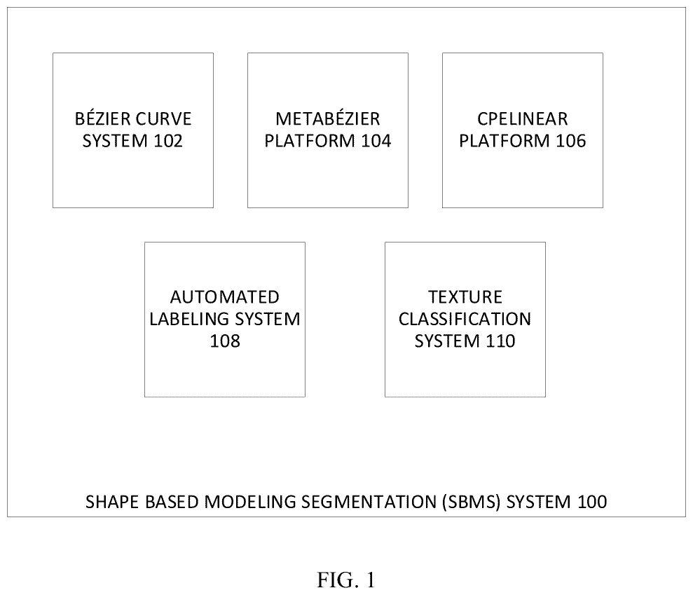

FIG. 1 is a block diagram of a Shape Based Modeling Segmentation (SBMS) system used in accordance with some embodiments. SBMS system 100 may apply auditable mathematical models (for example, Bézier curves, Class Perimeter Element Linear (CPELinear), and decision trees) to images comprised of pixels to collect hard data from visual imagery and significantly increase the speed and accuracy of object recognition. SBMS system 100 may include a Bézier curve system 102, a MetaBézier platform 104, a CPELinear platform 106, an automated labeling system 108, and a texture classification system 110.

Bézier curve system 102 may model fit edges and/or gradient runs parsed from an image into generated Bézier curves. MetaBézier platform 104 may connect MetaBézier curves together in an automated way to identify manmade objects (for example, vehicles and weapons) and anthropogenic objects (for example, construction and street scenes), with no training. MetaBézier platform 104 may find Bézier curves at multiple thresholds and multiple resolutions. These Bézier curves may be scale and angle invariant, may reliably handle occluded objects, and may be linked together to reliably find convex objects, whether occluded or not, with no calibration.

CPELinear platform 106 may detect and parse occluded objects having linear or very slightly curved boundaries, such as buildings, cultivated fields, boxes, cartons, and bins. CPELinear platform 106 may be used to find extended objects such as roads, rivers, railroad tracks, pipelines, power lines, or shorelines as opposed to compact objects. CPELinear platform 106 may serve as a complement to MetaBézier platform 104 which may be used to detect and parse objects having convex boundaries and using Bézier curves.

Automated labeling system 108 may use MetaBézier curves to identify specific classes of objects including, for example, an aircraft, a road, a pipeline, a vehicle, a person, or a weapon. Texture classification system 108 may perform robust texture classification including, for example, classification of weather, smoke, gas clouds, oncology diagnostics, plumes with appropriate sensors, and bone density. The functions of one or more of Bézier curve system 102, MetaBézier platform 104, CPELinear platform 106, automated labeling system 108, and texture classification system 110 may be implemented on a single computing device or on more than one computing devices.

Bézier curve system 102 may convert ground-truth pixels, generated by conventional image sensors, into Bézier curves of cubic (third) order. Cubic Bézier curves may be used to accurately model elliptical objects around their entire circumference using only four Bézier curves. In some cases, eight Bézier curves may be used to achieve the same accuracy as quadratic Bézier curves.

Cubic Bézier curves may be characterized by four geometric points, called “control points.” Two of these control points may be located at the endpoints of the Bézier curve. The other two may be located to give the Bézier curve its desired shape. In an implementation, the X and Y values of the end control points may be integers; the other two control points may be floating-point numbers. Movements of the control points may modify the shape of the corresponding Bézier curve in a predictable and intuitive way.

Bézier curves are mathematical functions that may be expressed in a way that may make it comparatively easy to fit them to characterize real shapes using the control points. They may take the form of polynomials having coefficients that are derived from the position of the control points. Bézier curves in two dimensions may be described in “parametric form,” as two polynomials, each in a parameter traditionally identified as t. One of the polynomials may express the x-coordinate of one point on the Bézier curve as a function of t, the other polynomial may express the y-coordinate of the point as a function of t.

Bézier curve system 102 may parse an image into “edges” and “gradient runs.” Edges may be generally tree structures, made up of large numbers of “trigger pixels,” (i.e., pixels that have the characteristic of being located where the brightness undergoes a rapid change in one of four directions (North, South, East, or West)). Edges tend to become trees in the general case because nothing can guarantee that the end of a given edge—perhaps corresponding to the boundary of some object or feature of an object—will come to a well-defined end at precisely the point that corresponds to the visible edge of that object. Another nearby object, for example, a background feature or a lighting artifact such as a shadow, may give rise to a continuation of the apparent edge in a manner that has nothing to do with the morphology of the object to which the original edge corresponds.

Regions that are neither edges nor gradient runs may be those in which edges may lack sufficient contrast to be detected under current lighting conditions. Once a first-pass survey is complete, the resulting orderly edges (recovered from locations that are in general buried deep within a tree structure) may be submitted to a Bézier-fitting algorithm. By the time a Bézier fit process takes place, the pixels that make up the putative Bézier curve may already be precisely known.

The parsing of the image into orderly edges and the fitting of Bézier curves to these edges may allow for the discovery of a morphological hierarchy between Bézier curves. This hierarchy may illuminate an authority system of confidence that exists between Bézier curves that arise from a real physical object. The hierarchy between Bézier curves may not exist with pixels arising from noise or from objects at the extreme limit of resolving power of the camera-optics-lighting system. The discovery of the hierarchy may be based on a geometric correspondence between Bézier curves detected at different sensitivity thresholds and/or different levels of resolution.

Sensitivity thresholds and resolution levels may be obtained, for example, by changing a trigger threshold for edge detection, by down sampling the image by simple (and therefore robust) pixel averaging methods, or by more physical means, such as by changing illumination power, the placement of illumination sources, or by moving the camera platform itself to put more pixels on the object under examination. This may be done by issuing commands to a motion-control system to which a camera is attached, as in the case of a robotic platform.

After Bézier curve system 102 fits and generates Bézier curves from an image, MetaBézier platform 104 may identify the Bézier curves in predefined proximity. The Bézier curves within the predefined proximity may have at least a geometric relationship or a reporting relationship with other Bézier curves in the predefined proximity. MetaBézier platform 104 may generate MetaBézier curves from the Bézier curves within the predefined proximity. A MetaBézier curve is a Bézier curve that has been corroborated within the predefined proximity. MetaBézier curve may have a geometric relationship with other nearby Bézier curves within the predefined proximity in the image and may be generated based upon corroboration or reporting relationships with the nearby Bézier curves within the predefined proximity. MetaBézier shape elements may solve the practical necessity of decreasing the number of raw Bézier curves that were generated from a single object boundary.

MetaBézier platform 104 may generate MetaBézier curves and connect the MetaBézier curves in an automated manner to identify, for example, manmade objects: streets, construction sites, and other objects of potential interest. MetaBézier curves may establish a hierarchy between Bézier curves detected at different thresholds, for example, a resolution and sensitivity level. When taken together, the hierarchical arrangement of Bézier curves may have greater credibility (for example, for the direction of curvature and boundary location) than does any individual Bézier curve, thereby dramatically improving reliability and decreasing training time.

Lower-resolution Bézier curves may have a very low probability of curving incorrectly but may be less accurate for locating the actual, literal edge of an object. Conversely, higher-resolution Bézier curves may be more accurate in their characterization of the location of literal edges but have a higher probability of incorrect curvature. Having an accurate assessment of which Bézier curves are curved correctly is important for locating and segmenting objects because one can link the correctly curved Bézier curves together in a closed path in many cases. Even in those cases where occlusions, shadows, or other appearance variables interrupt the visible closed path around a particular object, a certain fraction of the enclosing boundary path may be visible, from which the identity of the object can be ascertained and the non-visible portion of the enclosing boundary extrapolated from a geometrical model of that object which is stored in vector form; this is referred to as an “object model”.

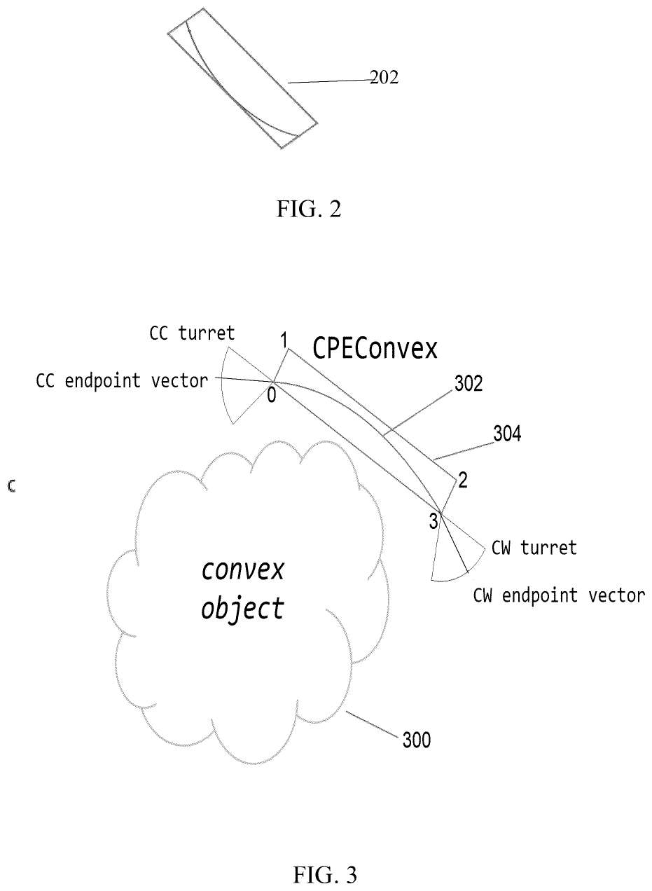

MetaBézier platform 104 may establish a hierarchy of authority within groups of Bézier curves located within proximity to one another. MetaBézier platform 104 may make the initial association by way of “wrapping” or applying rectangles or wraptangles 202 to connected Bézier curves. Wraptangles 202 are bounding rectangles that may be defined by a line segment that connects the endpoints of each Bézier curve, as shown in FIG. 2. Wraptangles 202 may be used to “stitch together” related Bézier curves into a connected object. The vertices of these wraptangles may be in general located at non-integral coordinates and may be represented using floating-point numbers.

Within the wraptangles, MetaBézier platform 104 may look to find other Bézier curves and establishes a hierarchy based on a threshold, for example, resolution. As described above, the lower-resolution Bézier curves may have a high probability of curving in the correct direction (i.e., being oriented to be concave toward the interior of the object that is to be recognized and isolated). MetaBézier platform 104 may use this directionality preference of Bézier curves as a means for linking a set of boundaries Bézier curves into a closed path that would enclose an object to be recognized and isolated. Geometric rules characterized mainly by angular displacement criteria may then be used to assign a class identity to the object based on shape.

MetaBézier platform 104 may include a Class Perimeter Element Convex (CPEConvex) class. CPEConvex class may be used to detect and parse objects having convex boundaries and may be built around a Bézier curve that has the structure 300 shown in FIG. 3. CPEConvex class may include a Bézier foundation curve 302 and a Bézier wraptangle 304, for example, a rectangle that encloses every part of Bézier curve 304. Bézier wraptangle 304 may include vertices labeled 0-3, wherein 0 vertex may be at Bézier curve clockwise (CW) endpoint, 3 vertex may be at Bézier curve counterclockwise (CC) endpoint and provision for a space to be allowed between the Wraptangle's 1-2 edge and the Bézier point furthest from (and parallel to) the 0-3 edge. CPEConvex class may include counterclockwise (CC) turrets and (CW) clockwise turrets that may be defined by two angles and a radius. These angles may be defined relative to the endpoint angles of the foundation curve. The turret radius may be defined in terms of the length of the foundation curve. Bézier curves may be connected end-to-end by detecting overlap between their Wraptangles, or by detecting overlap of their turrets. Turret overlap may be used to bridge gaps in boundary evidence for a given object in an image.

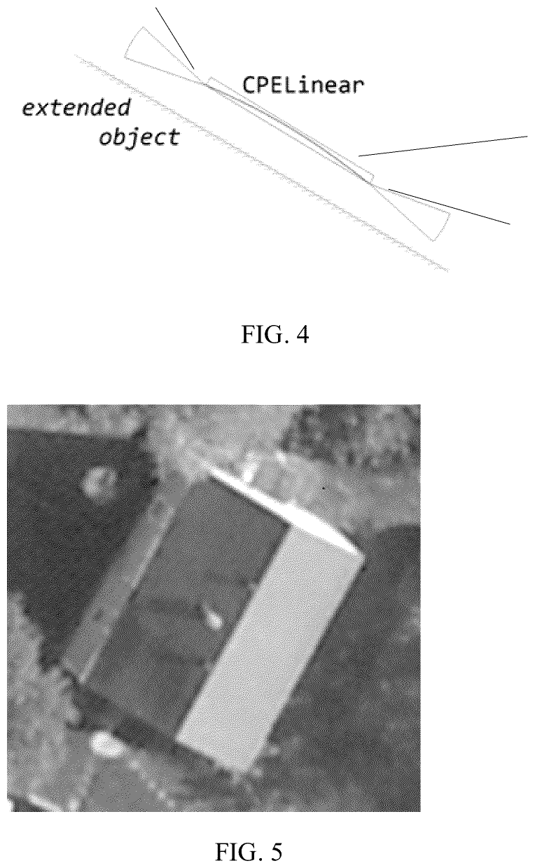

CPELinear platform 106 may include a CPELinear class which may include the same components as the CPEConvex class. The turret angles 402 and 404 in the CPELinear class may be referenced to the angle of the 0-3 edge of the enclosing Wraptangle 406. In the CPELinear class, the turrets may be symmetrical about this angle, as shown in FIG. 4. CPELinear perimeter elements may connect by means of Wraptangle overlap, or by turret overlap. CPELinear elements may thus be used to detect and parse occluded boundaries of extended objects. CPELinear class allows for longitudinal corroboration of Bézier curves. This capability encompasses connection “the long way” and complements “lateral corroboration” methodology giving rise to an abstraction of MetaBéziers in two dimensions, both lateral and longitudinal. Longitudinal corroboration may be used for detecting extended objects, that is, objects that are not compact, and therefore cannot be counted on to have mostly convex boundaries. It may also be used for the detection of objects that are bounded by straight lines.

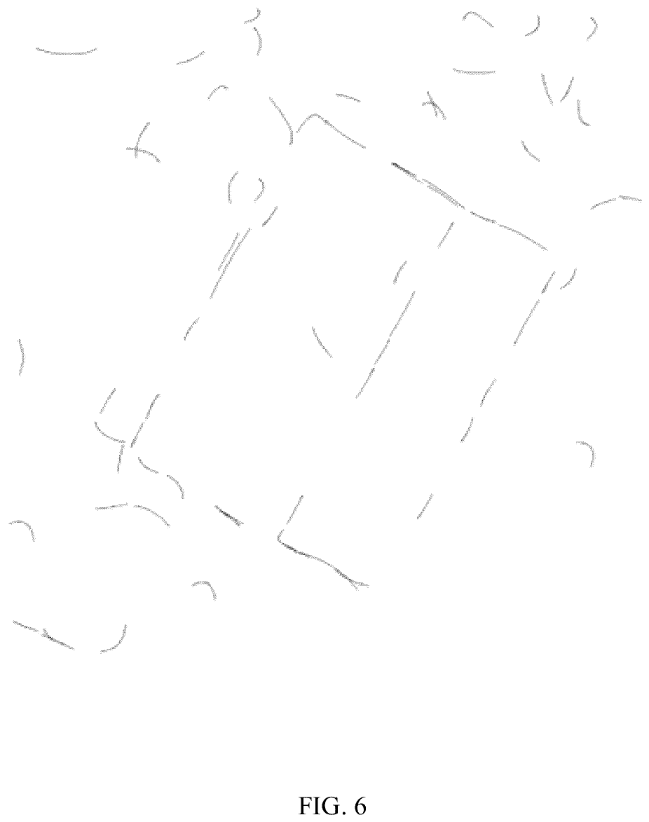

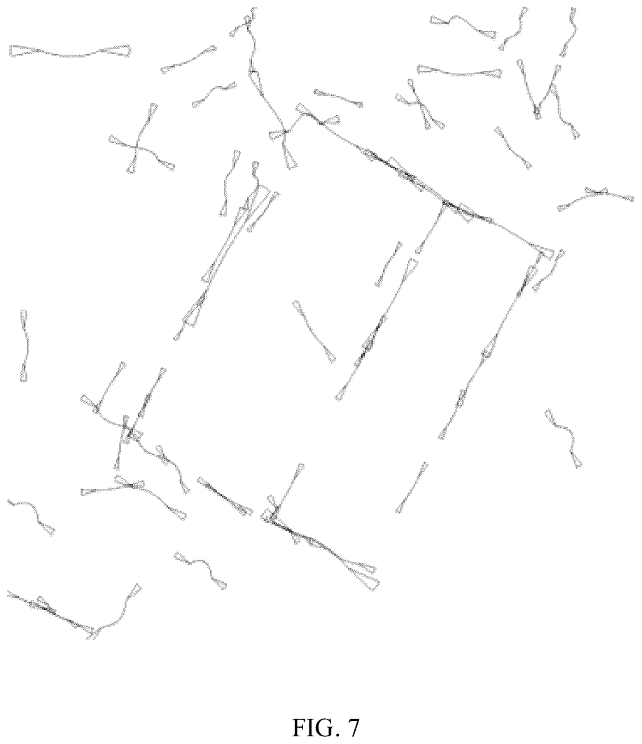

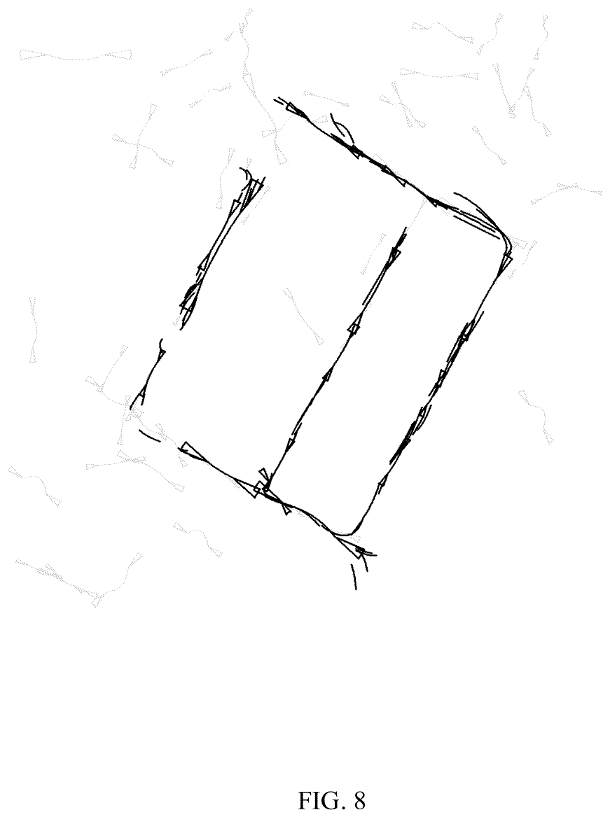

FIG. 5 shows an up-sampled image of a house processed using CPELinear platform 106 in accordance with some implementations. FIGS. 6-8 show a progressive analysis of this house using the CPELinear class of the CPELinear platform 106 in accordance with some implementations. FIG. 6 shows Bézier Curves of the roof of the house derived using CPELinear platform 106. FIG. 7 shows turrets or connectors for the Bézier curves outlined in FIG. 6.

FIG. 8 shows longitudinal TriBéziers (groups of three Béziers) detected from FIG. 6 and generated from longitudinal corroboration. In FIG. 8, the Béziers have not been filtered for straightness. Straight line segments may be detected by further filtering and correlating these TriBézier CPELinear perimeter elements

CPELinear platform 106 may be used to further corroborate the TriBéziers by detecting normal (right-angle) linkages between adjacent CPELinear elements. This may also allow for the detection of boundaries of architectural objects such as houses, streets, bridges, and power lines.

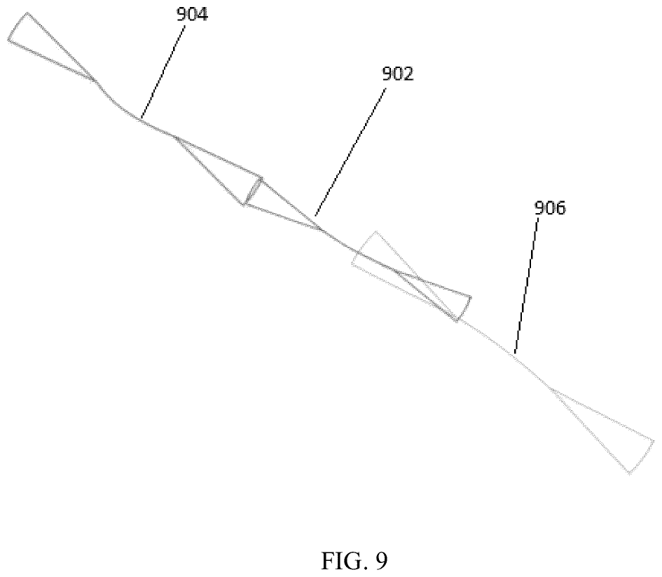

FIG. 9 further shows the longitudinal TriBéziers. Each longitudinal TriBéziers may be made of three Béziers having longitudinal overlap by means of either the Béziers themselves, or by “connect zones” (or “turrets”) extending from the ends of each. Here the “center” Bézier 902 has connecting Béziers 904 and 906. As with CPEConvex, the CPELinear elements can be linked together based on the overlap of their various parts with parts of other CPELinear perimeter elements. By doing this, paths of large extended objects may be completed as well as those around architectural features.

CPELinear platform 106 may further increase the number of detected endpoints of groups of CPELinear objects to detect populations of endpoints that are aligned with each other in precise angular relationships. In the CPELinear platform 106, a basic grouping of CPELinear elements may be the “TriBézier,” or group of three Béziers linked end to end and tested for alignment angle.

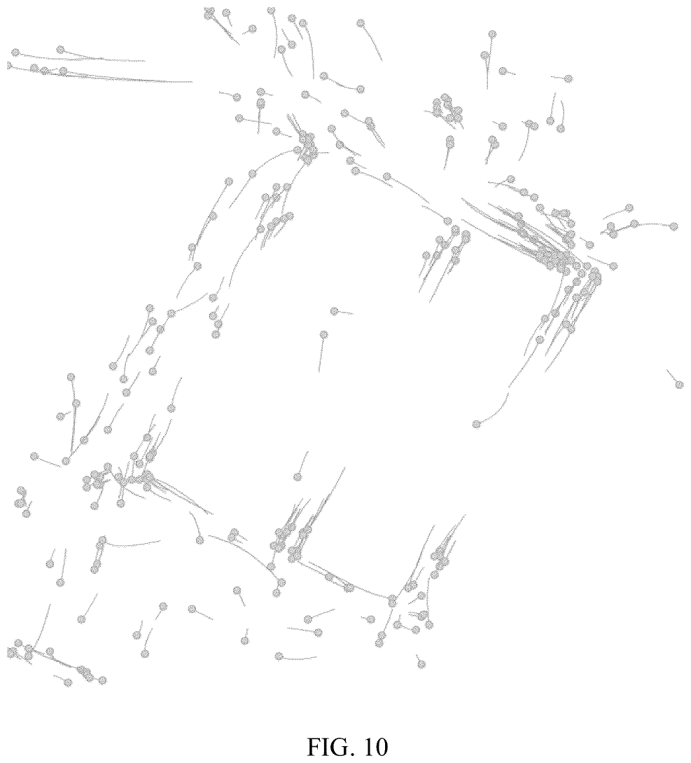

In some implementations, groups of two Béziers could be used to reliably detect the endpoints of linear features within the image. Using the image of FIG. 5, FIGS. 10-14 show further analysis of the up-sampled image of FIG. 5. FIG. 10 shows an image including single-BiBézier (pair of aligned Béziers) groups having an end Bézier in common with a full TriBézier. The circles indicate the “free end” of the BiBézier; that is, the end not shared with any TriBézier.

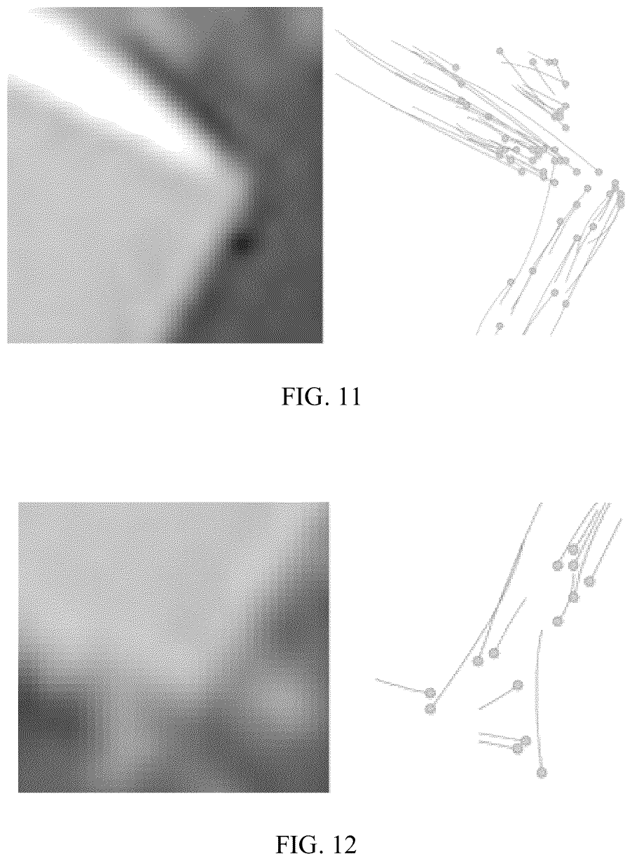

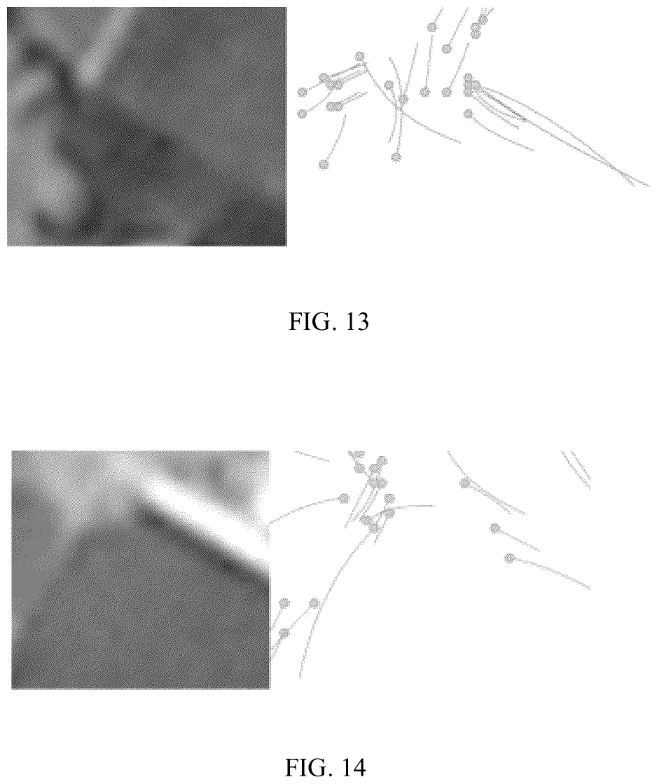

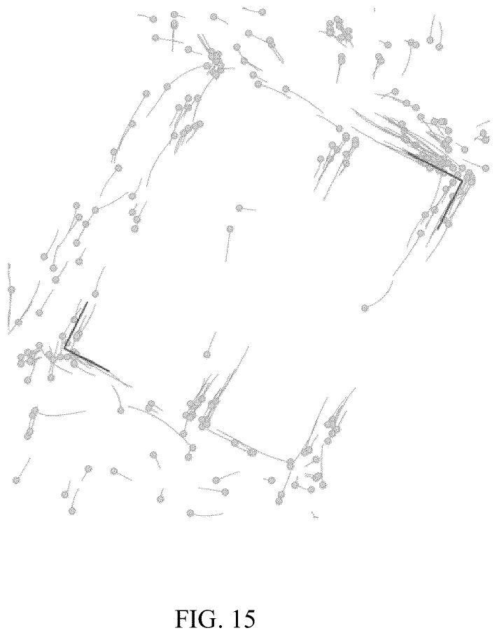

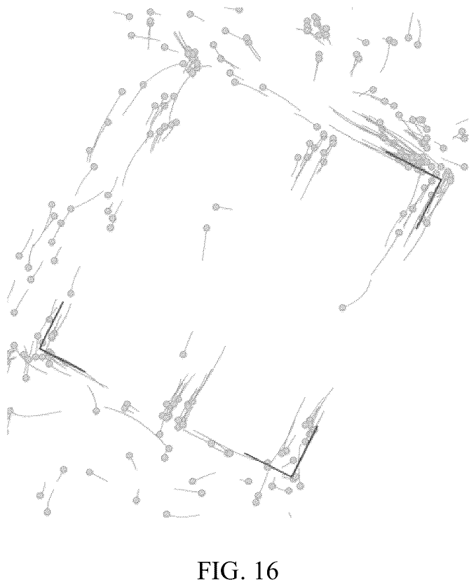

FIG. 11 shows an image including Bézier representing the upper right of the house. FIG. 12 shows an image including Bézier representing the lower right of the house. FIG. 13 shows an image including Bézier representing the lower left of the house. FIG. 14 shows an image including Bézier representing the upper left of the house. To find quadrilaterals formed from straight Béziers that correspond to line segments, two or three right-angle groups may be grouped together by means of their concave sides. FIG. 15 shows an image including Bézier representing diagonally opposing pairs. FIG. 16 shows an image including Bézier representing a group of three right-angle primitives; another alternative for finding quadrilaterals formed from straight Béziers. MetaBézier platform 104 and CPELinear platform 106 may thus be used to detect primitives that are linked by overlapping concavities and angular alignment.

SBMS 100 may combine the elements mentioned above and may be used as a prototype coordinate system generator for overhead photography of architectural structures. SBMS 100 may also be used to generalize the coordinate system definition process for ellipses to the problem of parsing vectorized overhead photography of man-made structures into separate buildings. Examples include, but are not necessarily limited to houses, urban buildings and structures, parking garages, agricultural fields, pools and rectangular liquid storage facilities, and rail cars. To find man-made structures, SBMS 100 may set up a separate rectangular coordinate system for each structure because most structures are built on a rectangular floor plan, with planar sides and right-angle (or nearly right-angle) corners.

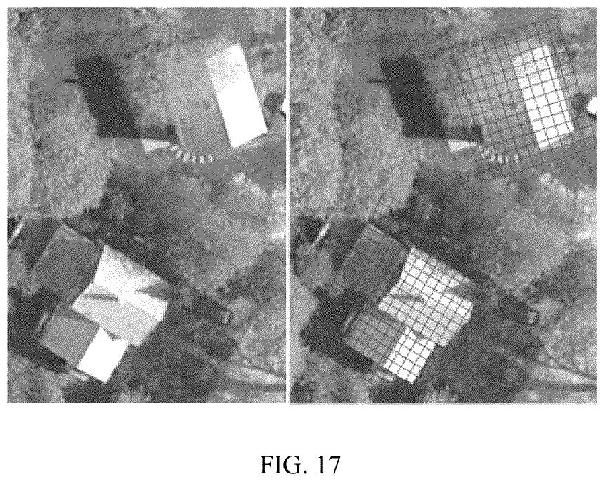

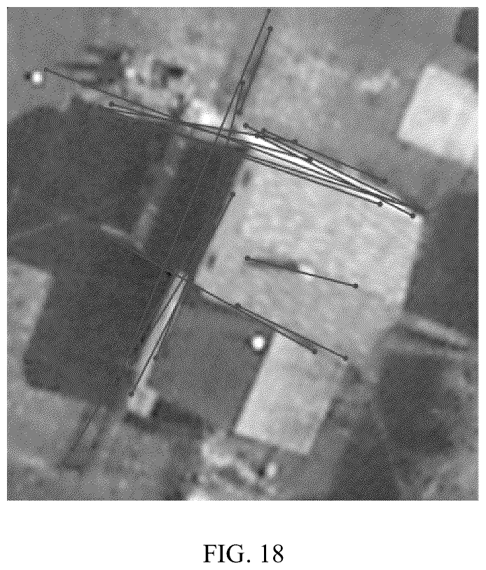

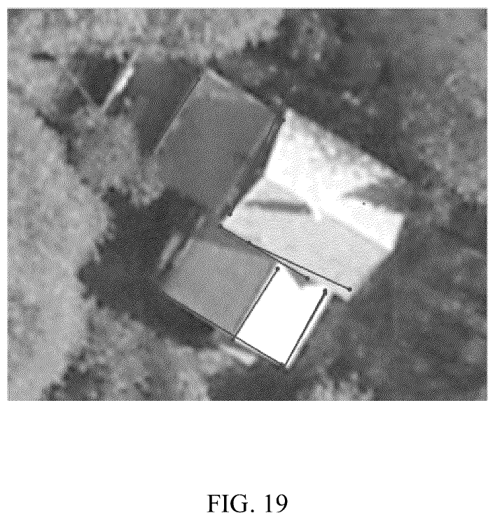

FIG. 17 shows an example of the coordinate system in accordance with some implementations. In this example, each structure has its own independent rectangular coordinate system. While one cannot depend on the “X” and “Y” axes of these coordinate systems being strictly orthogonal, depending on the slant angle from the camera point of view to the object of interest, foreshortening will normally cause the two axes to meet at an angle other than 90 degrees. FIGS. 18 and 19 show how CPELinear Class Elements may be used to reliably identify houses and buildings.

SBMS 100 may also be used for object identification, for example, in assembly, maintenance, and manufacturing. In addition to improving the robustness of object recognition under real-world conditions, SBMS 100 may handle occlusions which may help with the problem of finding the best point of view for a robotic vision system autonomously. This may involve simply moving the camera head and lighting through a series of movements that would produce the “least occluded image,” and doing this autonomously. This least occluded point of view may be useful for planning the least obstructed path of access for tools, and end effectors. This may allow the robot to “set itself up for success” without human interaction and its attendant transmission delays.

SBMS 100 is auditable such that if an unexpected result arises, the process may be audited. A robust field of data may allow SBMS 100 to go back and look at what worked and what didn't work, and attempt to fix the problem in real-time, without having to wait for another round of training.

In an implementation where SBMS 100 may be used in an orbital assembly to connect two cables, SBMS 100 may enable an autonomous robot to position itself to get a good view of the workplace and discover whether the items necessary to complete the task are present in the field of view as expected. If the necessary items are not present in the field of view, SBMS 100 may enable the autonomous robot to plan a search path to find the missing elements and bring them into the field of view. SBMS 100 may enable an autonomous robot to plan the path for movement of end effectors to get them into position to grasp, grip, twist, orient, or rotate the cable connectors into position to be joined, inspect its work, make measurements, check the alignment of angles or locking pins or registration marks on connector shells, etc., and plan the path of movement to withdraw the end effectors from the workplace without damaging anything. Using SBMS 100, the autonomous robot may enable an autonomous robot may not need a complete view of an object.

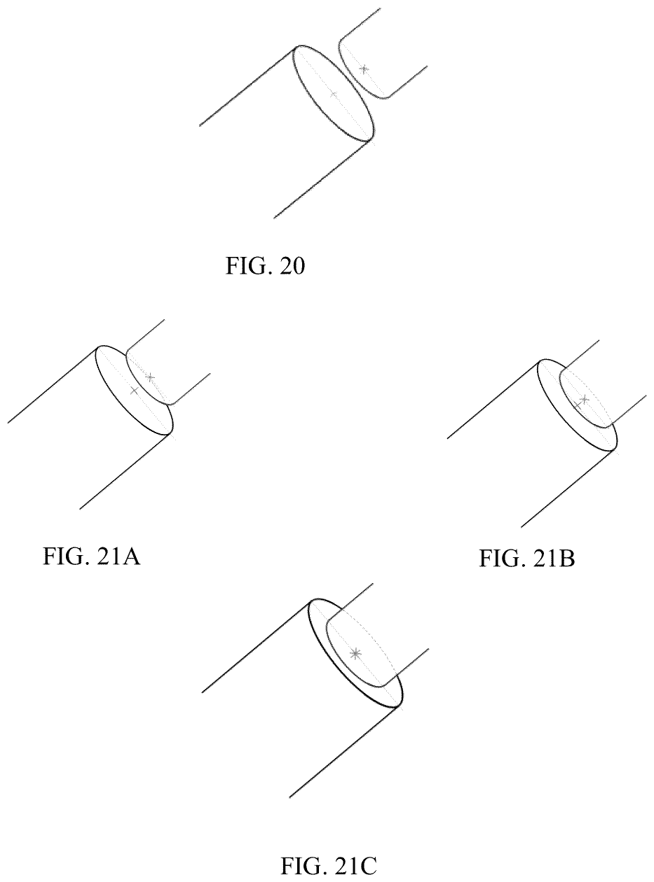

FIG. 20 shows two separate cables that need to be connected at any arbitrary angle, wherein the cable ends may be aligned both radially and longitudinally. FIGS. 21A-21C show the cable ends brought to proximity along a mutual radial axis; the occluded margin of the larger connector shell may be interpolated by SBMS 100. A final check for alignment in the connector face plane and longitudinally may be performed by SBMS 100 interpolation. The connector shells may advance to a point of the desired alignment, verified by the SBMS rules/shape model. The connector shells may be combined with force sensor data to provide cross-verification.

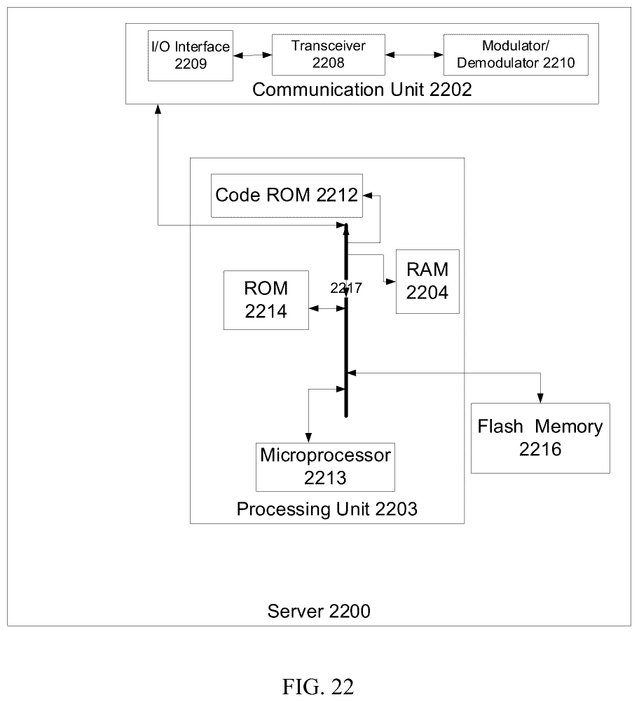

FIG. 22 is a block diagram of a computing device on which SBMS system 100 may be executed in accordance with some implementations and/or components of SBMS system in accordance with some implementations. Server 2200, for example, may include a communications unit 2202 coupled to a common data and address bus 2217 of a processor 2203. The processor 2203 may include a code read-only memory (ROM) 2212 for storing data for initializing system components of server 2200. The processor 2203 may further include a microprocessor 2213 coupled, by the common data and address bus 2217, to one or more memory devices, such as read-only memory (ROM) 2214, a random-access memory (RAM) 2204, and/or a static or flash memory 2216. One or more of ROM 2214, RAM 2204, and flash memory 2216 may be included as part of processor 2203 or may be separate from and coupled to processor 2203.

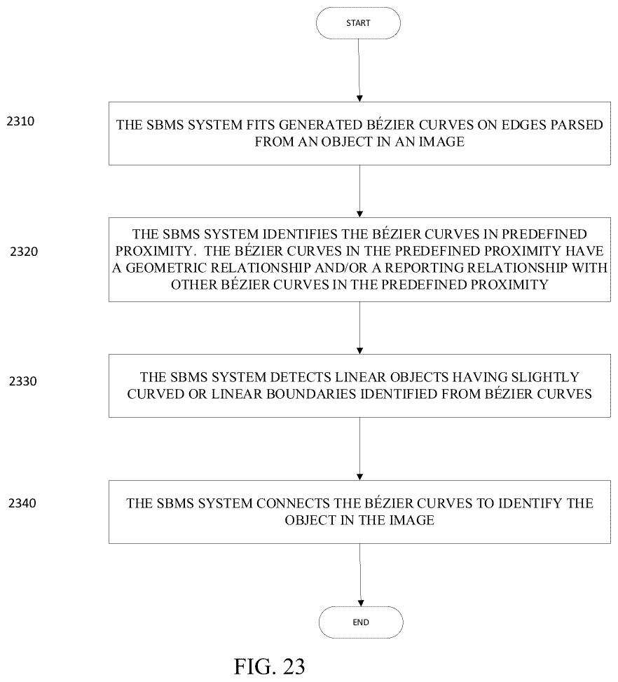

Communications unit 2202 may include a wired or wireless input/output I/O interface 2209 that may communicate with network components and other user equipment within its communication range. Communications unit 2202 may include one or more broadband and/or narrowband transceivers 2208 and/or other similar types of wireless transceivers that may communicate via a wireless network for infrastructure communications. Communications unit 2202 may also include one or more local area networks or personal area network transceivers. The transceivers may be coupled to a combined modulator/demodulator 2210. One or more memory devices 2212, 2214, and 2216 may store non-transitory computer-executable instructions to perform a set of functions such as one or more of the steps set forth in FIG. 23.

The number and arrangement of components shown in FIG. 22 are provided as an example. In practice, the device of FIG. 22 may include additional components, fewer components, different components, or differently arranged components than those shown in FIG. 22. Additionally, or alternatively, a set of components (e.g., one or more components) of the device of FIG. 22 may perform one or more functions described as being performed by another set of components of the device of FIG. 22.

FIG. 23 shows the steps implemented in accordance with some embodiments. In 2310, the SBMS system fits generated Bézier curves on edges parsed from an object in an image. In 2320, the SBMS system identifies the Bézier curves in predefined proximity. The Bézier curves in the predefined proximity have a geometric relationship and/or a reporting relationship with other Bézier curves in the predefined proximity. In 2330, the SBMS system detects linear objects having slightly curved or linear boundaries identified from Bézier curves. In 2340, the SBMS system connects the Bézier curves to identify the object in the image.

In the foregoing specification, specific embodiments have been described. However, one of ordinary skills in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method comprising:
fitting generated Bézier curves on edges parsed from an object in an image, by a Shape Based Modeling Segmentation (SBMS) system;
identifying, by the SBMS system, Bézier curves in a predefined proximity, the Bézier curves having at least one of a geometric relationship and a reporting relationship with other Bézier curves in the predefined proximity;
detecting, by the SBMS system, linear objects having at least one of slightly curved and linear boundaries identified from Bézier curves; and
connecting, by the SBMS system, the Bézier curves to identify the object in the image.

2. The method of claim 1, further comprising finding extended objects based on the detecting of linear objects.

3. The method of claim 2, further comprising executing, by the SBMS system, a class perimeter class linear (CPELinear) class to detect and parse occluded boundaries of extended objects.

4. The method of claim 3, wherein the CPELinear class includes a Bézier foundation curve and a Bézier wraptangle.

5. The method of claim 4, wherein the CPELinear class includes a counterclockwise turret and a clockwise turret, the counterclockwise turret and the clockwise turret are symmetrical to an endpoint angle of the Bézier foundation curve.

6. The method of claim 5, further comprising connecting Bézier curves end-to-end by at least one of detecting overlap between Bézier wraptangles and by detecting overlap of Bézier turrets.

7. The method of claim 5, further comprising using CPELinear elements to detect and parse occluded boundaries of extended objects.

8. The method of claim 3, further comprising using the CPELinear class for longitudinal corroboration of Bézier curves.

9. The method of claim 3, further comprising using the CPELinear class for longitudinal corroboration of TriBéziers curves by detecting right-angle linkages between adjacent CPELinear elements.

10. The method of claim 3, further comprising using the CPELinear class to increase a number of detected endpoints of groups of CPELinear objects to detect populations of endpoints that are aligned in precise angular relationships.

11. The method of claim 3, further comprising executing the CPELinear class on groups of two Béziers to detect endpoints of linear features within the image.

12. A Shape Based Modeling Segmentation (SBMS) system comprising:
a Bézier curve system to fit generated Bézier curves on edges parsed from an object in an image; and
a CPELinear platform to identify the Bézier curves in a predefined proximity, the Bézier curves having at least one of a geometric relationship and a reporting relationship with other Bézier curves in the predefined proximity, detect linear objects having at least one of slightly curved and linear boundaries identified from the Bézier curves, and connect the Bézier curves to identify the object in the image.

13. The SBMS system of claim 12, wherein the CPELinear platform finds extended objects based on detecting linear objects.

14. The SBMS system of claim 12, wherein the CPELinear platform executes a CPELinear class to detect and parse occluded boundaries of extended objects.

15. The SBMS system of claim 14, wherein the CPELinear class includes a Bézier foundation curve, a Bézier wraptangle, a counterclockwise turret, and a clockwise turret, the counterclockwise turret and the clockwise turret are symmetrical to an endpoint angle of the Bézier foundation curve.

16. The SBMS system of claim 15, wherein the CPELinear platform connects Bézier curves end-to-end by at least one of detecting overlap between Bézier wraptangles and by detecting overlap of Bézier turrets.

17. The SBMS system of claim 15, wherein the CPELinear class is used for longitudinal corroboration of Bézier curves.

18. The SBMS system of claim 15, wherein the CPELinear class is used for longitudinal corroboration of TriBéziers curves by detecting right-angle linkages between adjacent CPELinear elements.

19. The SBMS system of claim 15, wherein the CPELinear class is used to increase a number of detected endpoints of groups of CPELinear objects to detect populations of endpoints that are aligned in precise angular relationships.

20. The SBMS system of claim 15, wherein the CPELinear class is used on groups of two Béziers to detect the endpoints of linear features within the image.
